(19) United States
(12) Patent Application Publication
(10) Pub. No.: US 2025/0061627 A1
(43) Pub. Date: Feb. 20, 2025

(54) INFORMATION PROCESSING APPARATUS, INFORMATION PROCESSING METHOD, AND COMPUTER-READABLE MEDIUM

(71) Applicant: NEC Corporation, Minato-ku, Tokyo (JP)

(72) Inventor: Tomoki Kitahori, Tokyo (JP)

(73) Assignee: NEC Corporation, Minato-ku, Tokyo (JP)

(21) Appl. No.: 18/721,255

(22) PCT Filed: Jan. 14, 2022
(86) PCT No.: PCT/JP2022/001040

§ 371 Date: Jun. 18, 2024

(51) Int. Cl. G06T 11/60; G06V 10/44

(52) U.S. Cl. CPC G06T 11/60; G06V 10/44

(57) ABSTRACT

An information processing apparatus includes a generation unit configured to generate, based on a first image taken of a person at a first angle of depression, a pseudo image corresponding to an image taken of the person at a second angle of depression different from the first angle of depression. The generation unit is configured to perform transformation on an image region of a head part of the person difference from that performed on an image region of a torso part of the person. The information processing apparatus includes a creation unit for creating, based on the pseudo image, a recognition dictionary of the person whose image is taken at the second angle of depression.

### TECHNICAL FIELD

The present disclosure relates to an information processing apparatus, an information processing method, and a computer-readable medium, and in particular, to a technique for transforming images of people.

### BACKGROUND ART

Techniques for learning image features of objects and performing image recognition are known. Patent Literature 1 discloses an information processing apparatus for transforming an image taken by a dashcam to bring the imaging conditions of the image that has been taken by the dashcam to be similar to the imaging conditions of images used for training. According to the technique described in Patent Literature 1, the accuracy of image recognition can be improved.

Patent Literature 2 proposes a technique for performing an optimal image transformation process for each region of an image taken by a dashcam to thereby display a composite image without discomfort. Non-Patent Literature 1 discloses a technique for estimating the height of an obstacle based on an image taken using a monocular camera.

### CITATION LIST

### Patent Literature

Patent Literature 1: Japanese Unexamined Patent Application Publication No. 2019-125116
Patent Literature 2: Japanese Unexamined Patent Application Publication No. 2005-223568

### Non Patent Literature

Non-Patent Literature 1: Keiko Nakajima, Shiho Tanaka, Takenao Okawa and Toshio Ito, “Estimation of obstacle height information based on images taken by monocular camera using projective transformation”, a collection of papers of the Symposium on Image Recognition and Understanding (MIRU2011).

### SUMMARY OF INVENTION

### Technical Problem

By the way, when images of a person are taken at different angles of depression from one another, the images in which the person is taken have distinctive features from one another. The term “image of a person” refers to an image taken of a person. For example, the ratio of the size of the image region of the upper part of a person (e.g., shoulders) to the size of the image region of the lower part of a person (e.g., feet) changes according to the angle of depression. Therefore, it is difficult to perform image recognition of a person whose image is taken at an angle of depression different from an angle of depression at which images used for training were taken.

In view of the above circumstances, an object of the present disclosure is to provide an information processing apparatus, an information processing method, and a computer-readable medium which are adapted to enable image recognition of a person in an image taken at an angle of depression different from an angle of depression at which images used for training were taken.

### Solution to Problem

In order to achieve the above object, according to the present disclosure, an information processing apparatus includes:
generating means for generating, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
creating means for creating, based on the pseudo image, a recognition dictionary of the person whose image is taken at the second angle of depression.

According to the present disclosure, an information processing apparatus includes:
storage means for storing a recognition dictionary generated based on a second image taken of a person at a second angle of depression;
generation means for generating, based on a first image taken of the person at a first angle of depression different from the second angle of depression, a pseudo image corresponding to an image taken of the person at the second angle of depression, in which transformation on an image region of a head part of the person is different from that performed on an image region of a torso part of the person; and
recognition means for recognizing features of a person appearing in the pseudo image by referring to the recognition dictionary.

According to the present disclosure, an information processing method includes causing a computer to execute processes of:
generating, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
creating, based on the pseudo image, a recognition dictionary of the person whose image is taken at the second angle of depression.

According to the present disclosure, an information processing method includes causing a computer to perform processes of:
generating, based on a first image taken of a person at a first angle of depression different from a second angle of depression, a pseudo image corresponding to an image taken of the person at the second angle of depression, in which transformation performed on an image region of a head part of the person is different from that performed on an image region of a torso part of the person; and
recognizing features of the person appearing in the pseudo image by referring to a recognition dictionary generated based on a second image which is the image taken of the person at the second angle of depression.

According to the present disclosure, a non-transitory computer-readable medium stores a program for causing a computer to execute an information processing method, the method including:
generating means for generating, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
creating means for creating, based on the pseudo image, a recognition dictionary of the person whose image is taken at the second angle of depression.

According to the present disclosure, a non-transitory computer-readable medium stores a program for causing a computer to execute an information processing method, the method comprising:
generating, based on a first image taken of a person at a first angle of depression different from a second angle of depression, a pseudo image corresponding to an image taken of the person at the second angle of depression, in which transformation performed on an image region of a head part of the person is different from that performed on an image region of a torso part of the person; and
recognizing features of the person appearing in the pseudo image by referring to a recognition dictionary generated based on a second image which is the image taken of the person at the second angle of depression.

### Advantageous Effects of Invention

An information processing apparatus, an information processing method, and a computer-readable medium according to the present disclosure is each adapted to enable image recognition of a person in an image taken at an angle of depression different from an angle of depression at which images used for training were taken.

### BRIEF DESCRIPTION OF DRAWINGS

FIG. 1 is a block diagram showing an information processing apparatus according to a first example embodiment;

FIG. 2 is a block diagram showing an information processing apparatus according to a second example embodiment;

FIG. 3 is a schematic diagram of a system including an information processing apparatus according to a third example embodiment;

FIG. 4 is a schematic diagram showing an image capturing apparatus installed in a vehicle;

FIG. 5 is a schematic diagram showing an image capturing apparatus installed in a truck;

FIG. 6 is a schematic diagram illustrating an image taken of a person from a height of 2 m;

FIG. 7 is a schematic diagram illustrating an image taken of a person from a height of 3 m;

FIG. 8 is a diagram for explaining the reasons for performing transformation on the image region of the head part different from that performed on the image region of the torso part; and

FIG. 9 is a diagram showing the generated pseudo image.

### EXAMPLE EMBODIMENT

Hereinafter, example embodiments of the present disclosure will be described in detail with reference to the drawings. In each drawing, the same or corresponding elements are given the same reference symbols, and duplicate descriptions thereof will be omitted as necessary for clarity of the description.

### First Example Embodiment

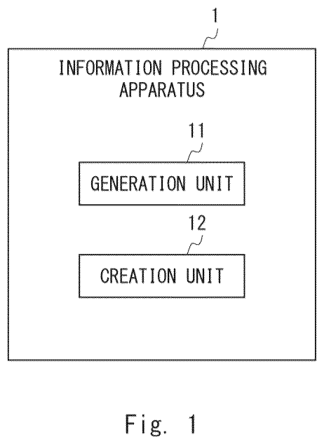

FIG. 1 is a block diagram showing an overall configuration of an information processing apparatus 1 according to a first example embodiment. The information processing apparatus 1 is an apparatus for creating a recognition dictionary of a person in an image taken at a second angle of depression based on a first image taken of a person at a first angle of depression. The first angle of depression and the second angle of depression are different angles from one another. The second angle of depression may be larger than the first angle of depression or may be smaller than the first angle of depression.

The information processing apparatus 1 may be connected, via a network (not shown), to a first image capturing apparatus (not shown) for taking an image of a person at the first angle of depression and a second image capturing apparatus (not shown) for taking an image of a person at the second angle of depression.

The information processing apparatus 1 includes a generation unit 11 and a creation unit 12. The generation unit 11 generates a pseudo image corresponding to an image taken at the second angle of depression different from the first angle of depression based on a first image taken at the first angle of depression. The generation unit 11 performs transformation on the image region of the head part of a person different from that performed on the image region of the torso part of the person.

The generation unit 11 may perform projective transformation on the image region of the torso part so that a quadrilateral representing the torso part is transformed into another quadrilateral. Projective transformation is also referred to as trapezoidal transformation. In the case where the quadrilateral representing the torso part is a trapezoid, the smaller the angle of depression is, the closer the ratio between the top and the bottom of the torso part may be to 1 in the image. In the case where the quadrilateral representing the torso part is a trapezoid, the larger the angle of depression is, the smaller the height of the torso part may be in the image. Thus, the type of the quadrilateral representing the torso part changes according to the angle of depression. By performing projective transformation, a pseudo image region corresponding to an image that is taken at a different angle of depression can be generated based on the image region of the torso part in the image.

The generation unit 11 may transform the image region of the head part so as to change the viewpoint from which the image of the head part is taken. When the angle of depression at which an image is taken is increased, the image region of the top of the head part in the image may be enlarged and the image region of the face in the image may be reduced. In this way, the image region of the head part changes according to the angle of depression. By changing the viewpoint, the image region of the head part can be transformed to a pseudo image region corresponding to the image taken at the second angle of depression. The viewpoint may be, for example, the position or the posture of the image capturing apparatus. As a technique for changing the viewpoint, the technique described in Non-Patent Literature 1 is known. The Non-Patent Literature 1 describes transforming an image that has been taken to a top view image.

The creation unit 12 creates a recognition dictionary of a person in an image taken at the second angle of depression using a pseudo image. The creation unit 12 may create a recognition dictionary by performing machine learning.

The information processing apparatus 1 generates a pseudo image corresponding to the image photographed at the second angle of depression, and creates a recognition dictionary using the pseudo image. By referring to the recognition dictionary, image recognition can be performed of the person whose image is taken at the second angle of depression.

The information processing apparatus 1 includes a processor, a memory, and a storage device as an unillustrated configuration thereof. The storage device stores a computer program for implementing the processing of the information processing method according to this example embodiment. The processor reads the computer program from the storage device into the memory and executes the computer program. Thus, the processor realizes the functions of the generation unit 11 and the creation unit 12.

Alternatively, the generation unit 11 and the creation unit 12 may each be implemented using dedicated hardware. In addition, some or all of the components of each apparatus may be implemented with a general-purpose or dedicated circuitry, a processor, or the like, or a combination thereof. These may be configured with a single chip or with a plurality of chips connected via a bus. Some or all of the components of each apparatus may be implemented by a combination of the above-mentioned circuits, etc., and a program. A CPU (Central Processing Unit), a GPU (Graphics Processing Unit), an FPGA (field-programmable gate array), a quantum processor (quantum computer control chip), etc., may be used as a processor.

In addition, when some or all of the components of the information processing apparatus 1 are realized by a plurality of information processing apparatuses, circuits, etc., the plurality of information processing apparatuses, circuits, etc. may be centrally arranged or discretely arranged. For example, information processing apparatuses, circuits, etc., may be realized in the form of a client-server system, a cloud computing system, etc., each of which is connected via a communication network. Further, the functions of the information processing apparatus 1 may be provided in the SaaS (Software as a Service) format.

### Second Example Embodiment

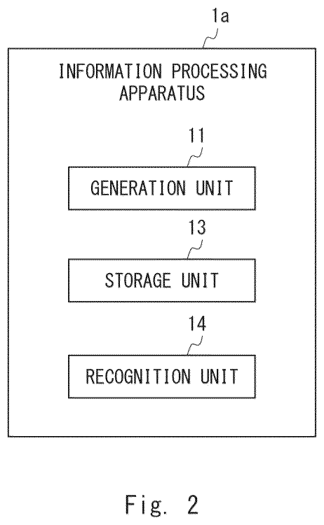

FIG. 2 is a block diagram showing an overall configuration of an information processing apparatus 1a according to a second example embodiment. The information processing apparatus 1a is an apparatus for performing image recognition by generating, based on a first image taken at the first angle of depression, a pseudo image corresponding to an image taken at the second angle of depression.

The information processing apparatus 1a includes the generation unit 11, a storage unit 13, and a recognition unit 14. Since the function of the generation unit 11 is the same as that of the image processing apparatus according to the first example embodiment, description thereof will be omitted. In the generation unit 11, a predetermined proportion (e.g., the upper ⅓ region) from the upper edge of the first image may be used as the image region of the head part, and image region other than the image region of the head part may be assumed as the image region of the torso part in the first image.

A recognition dictionary generated based on the second image which is an image taken of a person at the second angle of depression is pre-stored in the storage unit 13. The recognition unit 14 recognizes the features of a person appearing in a pseudo image by referring to the recognition dictionary. The recognition unit 14 can detect a person appearing in the pseudo image. The recognition unit 14 may refer to the recognition dictionary to identify an individual or to determine the attributes of a person.

The information processing apparatus 1a generates a pseudo image corresponding to an image taken at the second angle of depression, and performs image recognition by referring to the recognition dictionary corresponding to the image taken at the second angle of depression. The information processing apparatus 1a has the advantage of not having to prepare a recognition dictionary for images taken at each angle of depression at which image-taking is performed.

### Third Example Embodiment

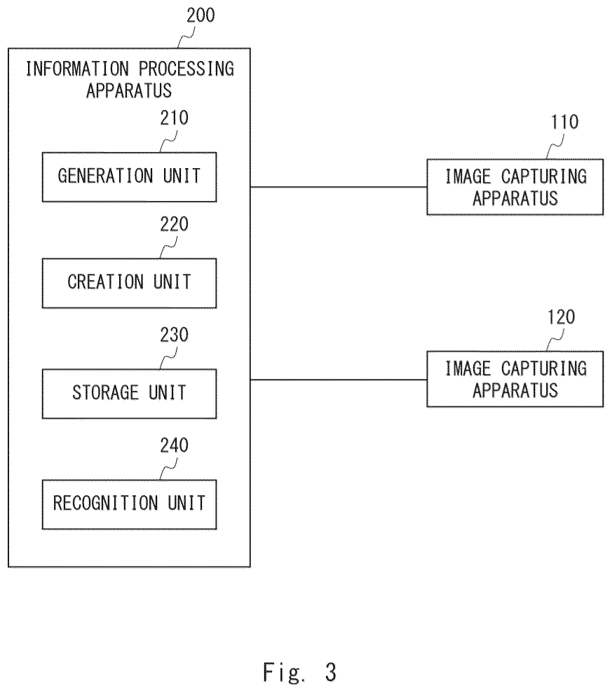

A third example embodiment is a specific example of the first example embodiment and the second example embodiment described above. FIG. 3 is a configuration diagram showing the configuration of a system including an information processing apparatus 200 according to the third example embodiment. The system shown in FIG. 3 includes an image capturing apparatus 110, an image capturing apparatus 120, and the information processing apparatus 200.

The image capturing apparatus 110 is also referred to as the first image capturing apparatus, and the image capturing apparatus 120 is also referred to as the second image capturing apparatus. The image taken with the image capturing apparatus 110 is referred to as the first image, and the image taken with the image capturing apparatus 120 is referred to as the second image. The information processing apparatus 200, which will be described later, is an apparatus for generating pseudo images corresponding to the first and second images.

The height of the image capturing apparatus 110 is different from the height of the image capturing apparatus 120. For example, the image capturing apparatus 110 may be mounted on passenger vehicles and the image capturing apparatus 120 may be mounted on heavy vehicles such as trucks, buses, etc. An image capturing apparatus 100 may be installed in a building or mounted on a pole in a town. In the following, when the image capturing apparatus 110 and the image capturing apparatus 120 are not distinguished from each other, they may simply be referred to as the image capturing apparatus 100.

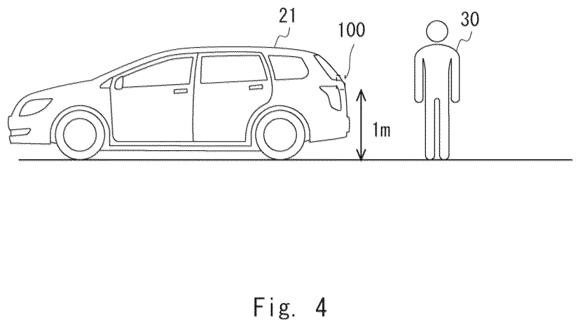

FIG. 4 is a schematic diagram showing a case in which the image capturing apparatus 100 is attached to a vehicle 21. The image capturing apparatus 100 is mounted on the rear of the vehicle 21. The height of the image capturing apparatus 100 is, for example, 1 m. The image capturing apparatus 100 takes an image of a person 30 behind the vehicle 21.

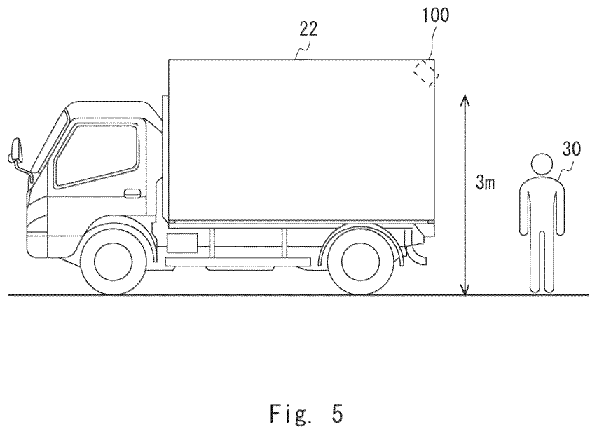

FIG. 5 is a schematic diagram showing a case in which the image capturing apparatus 100 is attached to a truck 22. The image capturing apparatus 100 may be a fisheye camera or an ultra-wide-angle camera capable of taking images across a wide area. Thus, it is possible to take images of a larger number of people and efficiently create a recognition dictionary.

The image capturing apparatus 100 is mounted on the rear of the truck 22. The image capturing apparatus 100 is mounted so as to face diagonally downward. The height of the image capturing apparatus 100 is, for example, 3 m. The image capturing apparatus 100 takes an image of the person 30 behind the truck 22. The angle of depression at which image-taking is performed may be defined by the height of the image capturing apparatus 100 and the horizontal distance between the image capturing apparatus 100 and the person 30.

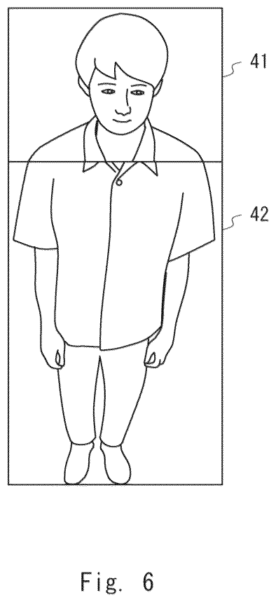

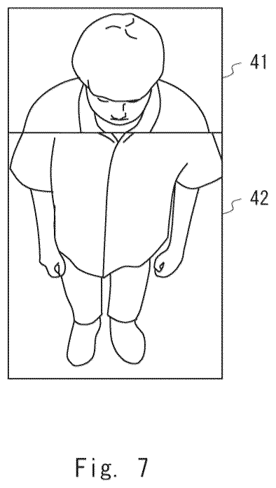

When the image capturing apparatus 100 is located at an elevated position, an image of the person 30 is taken at a larger angle of depression. FIG. 6 is a schematic diagram illustrating an image taken when the image capturing apparatus 100 is mounted at a height of 2 m. The captured image includes an image region 41 of the head part and an image region 42 of the torso part. FIG. 7 is a schematic diagram illustrating an image taken when the image capturing apparatus 100 is mounted at a height of 3 m. The captured image includes an image region 41 of the head part and an image region 42 of the torso part.

The image shown in FIG. 6 resembles an image of a person taken from the front, and it is considered that it is relatively easy to perform image recognition of the person. On the other hand, FIG. 7 illustrates an image of a person that differ significantly from an image of a person taken from the front and it is considered to be difficult to perform image recognition of the person.

Comparing FIG. 6 with FIG. 7, the quadrilaterals representing the torso parts of the person are different. The vertices of the quadrilateral may be, for example, the position of the right shoulder, the position of the left shoulder, the position of the right foot, and the position of the left foot of the person. The torso part of the person shown in FIG. 6 is illustrated as a rectangle, whereas the torso part of the person shown in FIG. 7 is illustrated as a trapezoid. Further, when comparing FIGS. 6 and 7, the face part is larger in FIG. 6, and top of the head part is larger in FIG. 7. The information processing apparatus 200 to be described later may generate, based on the image shown in FIG. 6, a pseudo image corresponding to FIG. 7 to create a recognition dictionary when image-taking is performed from a high position. The information processing apparatus 200 may generate, based on the image shown in FIG. 7, a pseudo image corresponding to FIG. 6 to detect a person by referring to a recognition dictionary. In this case, the recognition dictionary may be a dictionary for detecting a person in an image taken from the horizontal direction.

Referring again to FIG. 3, the information processing apparatus 200 will be described. The information processing apparatus 200 is a specific example of the information processing apparatuses 1 and 1a described above. The information processing apparatus 200 includes a generation unit 210, a creation unit 220, a storage unit 230, and a recognition unit 240. In the case where the information processing apparatus 200 is a specific example of the information processing apparatus 1, the information processing apparatus 200 may not include the storage unit 230 and the recognition unit 240. In the case where the information processing apparatus 200 is a specific example of the information processing apparatus 1a, the information processing apparatus 200 may not include the creation unit 220.

The generation unit 210 is a specific example of the generation unit 11 described above. The generation unit 210 generates, based on the first image, a pseudo image corresponding to an image taken at the second angle of depression. The generation unit 210 performs transformation on the image region 41 different from that performed on the image region 42. The generation unit 210 outputs the pseudo image to the creation unit 220 or the recognition unit 240.

The generation unit 210 may, for example, generate, based on an image taken of a person from overhead, a pseudo image corresponding to an image taken of the person from the horizontal direction. The information processing apparatus 200 can detect, by referring to an ordinary recognition dictionary, a person in an image taken from overhead. The generation unit 210 may also generate, based on an image taken of a person from the horizontal direction, a pseudo image corresponding to the image taken of the person from overhead. The information processing apparatus 200 can create a recognition dictionary for recognizing a person who appears in an image taken from overhead.

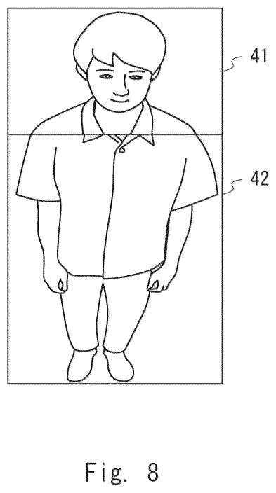

Next, the reason why the generation unit 210 performs transformation on the image region 41 different from that performed on the image region 42 will be explained. FIG. 8 shows the result of performing projective transformation on the whole image shown in FIG. 6 and generating a pseudo image corresponding to the image shown in FIG. 7. In other words, FIG. 8 shows the result of performing the same processing on both the image region 41 and the image region 42 as that performed by the generation unit 210 on the image region 42. The image region 42 of FIG. 8 is similar to the image region 42 of FIG. 7. On the other hand, the image region 41 of FIG. 8 and the image region 41 of FIG. 7 are significantly different. Since projective transformation does not change the orientation of the body in the image, it is considered that a proper image cannot be generated.

FIGS. 8 and 7 differ significantly. Therefore, when recognition dictionary is generated using the image shown in FIG. 8, it is considered that the recognition accuracy decreases. Therefore, the generation unit 210 partitions the first image into the image region 41 and the image region 42, and performs transformation on the image region 41 different from that performed on the image region 42.

The generation unit 210 may, for example, designate a predetermined proportion (e.g., ⅓) from the upper edge of the first image as the image region 41, and designate the region elsewhere in the image as the image region 42. When the first image is an image taken by a fisheye camera or an ultra-wide-angle camera, there is a possibility that the body part (e.g., face) cannot be detected because the image is distorted, but this method allows partitioning of the image into segments.

The generation unit 210 may also detect, based on the first image, the head part (e.g., face), thereby partitioning the first image into the image region 41 and the image region 42. Thus, the generation unit 210 can partition the first image more accurately.

Then, the generation unit 210 performs projective transformation on the image region 42, the projective transformation corresponding to image-taking performed at the second angle of depression. The projective transformation can transform any quadrilateral into a different quadrilateral. The transformation parameters used for the transformation may be defined according to an angle of depression. In the case where the image capturing apparatus 110 is a fisheye camera or the like, the generation unit 210 may correct distortion of the image region 41. In the case where the image capturing apparatus 120 is a fisheye camera or the like, the generation unit 210 may add distortion to the image region 41.

The generation unit 210 performs viewpoint transformation on the image region 41 so as to correspond to the image taken at the second angle of depression. The generation unit 210 may divide the image region 41 and perform different processing on each of the divided regions (e.g., region of the top of the head, region of the face). The generation unit 210 may perform data completion when performing viewpoint transformation. In the case where the image capturing apparatus 110 is a fisheye camera or the like, the generation unit 210 may correct distortion of the image region 41. In the case where the image capturing apparatus 120 is a fisheye camera or the like, the generation unit 210 may add a distortion to the image region 41. The viewpoint transformation may be performed according to the Non-Patent Literature 1. The generation unit 210 generates a pseudo image by combining the image region 41 that has been subjected to projective transformation and the image region 42 that has been subjected to viewpoint transformation.

When the image capturing apparatus 110 is installed at an elevated position, the generation unit 210 may perform transformation on the image region 41 and the image region 42 using the transformation parameters corresponding to the height of the image capturing apparatus 110. This is because the first angle of depression is also transformed based on the height of the image capturing apparatus 110. The image capturing apparatus 110 may store the transformation parameters for each height of the image capturing apparatus 110 in a form of a table. Similarly, in the case where the image capturing apparatus 120 is installed at an elevated position, the generation unit 210 may transform the image region 41 and the image region 42 using the transformation parameters corresponding to the height of the image capturing apparatus 120.

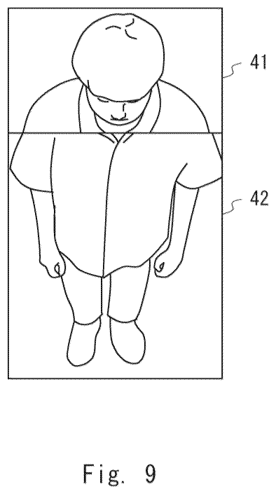

FIG. 9 shows a pseudo image generated based on the image shown in FIG. 6. Different transformations are performed for the image region 41 and the image region 42, and FIGS. 9 and 7 are not significantly different. While the recognition accuracy degrades as described above when the image shown in FIG. 8, in which the same transformations are performed for the image region 41 and the image region 42, is used, degradation in the recognition accuracy can be suppressed by using the image shown in FIG. 9.

The creation unit 220 is a specific example of the creation unit 12 described above. The creation unit 220 uses a pseudo image to create a recognition dictionary of a person whose image is captured at the second angle of depression. The creation unit 220 may create a recognition dictionary for each horizontal distance between the image capturing apparatus 120 and the person. This is because the larger the horizontal distance, the smaller the angle of depression, and therefore the features in the image in which a person is taken may also change. The larger the horizontal distance, the more the taken image resembles the image taken from the front, and the smaller the horizontal distance, the more the taken image resembles the image taken from the top.

The storage unit 230 is a specific example of the storage unit 13 described above. The storage unit 230 may store a recognition dictionary created by the creation unit 220. The storage unit 230 may further store a table in which the height of the image capturing apparatus 110 and the transformation parameters are stored in correspondence with each other.

The recognition unit 240 is a specific example of the recognition unit 14 described above. The recognition unit 240 recognizes, by referring to the recognition dictionary, the features of the person appearing in the second image thereby detecting a person in an image. The recognition unit 240 may recognize the features of a person by referring to the recognition dictionary corresponding to the horizontal distance between the person appearing in the second image and the image capturing apparatus 120. This is because the larger the horizontal distance, the smaller the angle of depression, and therefore the features of the person appearing in the image may also change. The horizontal distance may be determined in accordance with the size of the person appearing in the second image.

Lastly, the effects of the information processing apparatus 200 will be described. According to the related art, it was necessary to create a recognition dictionary for recognizing a person for each height of the image capturing apparatus 120. The information processing apparatus 200 has the advantage that it is not necessary to provide a recognition dictionary for each height of the image capturing apparatus 120.

While the present disclosure has been particularly shown and described with reference to example embodiments thereof, the present disclosure is not limited to these example embodiments, and various changes and modification may be made therein without departing from the spirit and scope of the present disclosure.

The whole or part of the example embodiments disclosed above can be described as, but not limited to, the following supplementary notes.

### (Supplementary Note 1)

An information processing apparatus comprising:
generating means for generating, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
creating means for creating, based on the pseudo image, a recognition dictionary of the person whose image is taken at the second angle of depression.

### (Supplementary Note 2)

The information processing apparatus according to Supplementary Note 1, wherein the generation means is configured to:
perform projective transformation on the image region of the torso part so that a quadrilateral representing the torso part is transformed into another quadrilateral; and
perform transformation on the image region of the head part so that the viewpoint from which an image of the head part is taken is changed.

### (Supplementary Note 3)

The information processing apparatus according to Supplementary Note 1 or 2, wherein the first image is an image taken with a fisheye camera or an ultra-wide-angle camera.

### (Supplementary Note 4)

The information processing apparatus according to Supplementary Note 3, wherein the generation means designates a predetermined proportion of the first image from an upper edge of the first image as an image region of the head part, and designates a region other than the region of the head part in the first image as the image region of the torso part in the first image.

### (Supplementary Note 5)

The information processing apparatus according to any one of Supplementary Notes 1 to 4, further comprising recognition means for recognizing features of a person appearing in the second image taken at the second angle of depression by referring to a recognition dictionary.

### (Supplementary Note 6)

The information processing apparatus according to Supplementary Note 5, wherein a height of a first image capturing apparatus for taking the first image is different from that of a second image capturing apparatus for taking the second image.

### (Supplementary Note 7)

The information processing apparatus according to Supplementary Note 6, wherein the creating means creates a recognition dictionary for each horizontal distance between the second image capturing apparatus and the person.

### (Supplementary Note 8)

An information processing apparatus comprising:
storage means for storing a recognition dictionary generated based on a second image taken of a person at a second angle of depression;
generation means for generating, based on a first image taken of the person at a first angle of depression different from the second angle of depression, a pseudo image corresponding to an image taken of the person at the second angle of depression, in which transformation performed on an image region of a head part of the person is different from that performed on an image region of a torso part of the person; and
recognition means for recognizing features of a person appearing in the pseudo image by referring to the recognition dictionary.

### (Supplementary Note 9)

The information processing apparatus according to Supplementary Note 8, wherein the generating means is configured to:
perform projective transformation on the image region of the torso part so that a quadrilateral representing the torso part is transformed into a quadrilateral of a different type; and
perform transformation on the image region of the head part so as to change the viewpoint from which an image of the head part is taken.

### (Supplementary Note 10)

An information processing method comprising causing a computer to execute processes of:
generating, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
creating, based on the pseudo image, a recognition dictionary of the person whose image is taken at the second angle of depression.

### (Supplementary Note 11)

An information processing method comprising causing a computer to perform processes of:
generating, based on a first image taken of a person at a first angle of depression different from a second angle of depression, a pseudo image corresponding to an image taken of the person at the second angle of depression, in which transformation performed on an image region of a head part of the person is different from that performed on an image region of a torso part of the person; and
recognizing features of the person appearing in the pseudo image by referring to a recognition dictionary generated based on a second image which is the image taken of the person at the second angle of depression.

### (Supplementary Note 12)

A non-transitory computer-readable medium that stores a program for causing a computer to execute an information processing method, the method comprising: generating means for generating, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
creating means for creating, based on the pseudo image, a recognition dictionary of the person whose image is taken at the second angle of depression.

### (Supplementary Note 13)

A non-transitory computer-readable medium that stores a program for causing a computer to execute an information processing method, the method comprising:
generating, based on a first image taken of a person at a first angle of depression different from a second angle of depression, a pseudo image corresponding to an image taken of the person at the second angle of depression, in which transformation performed on an image region of a head part of the person is different from that performed on an image region of a torso part of the person; and
recognizing features of the person appearing in the pseudo image by referring to a recognition dictionary generated based on a second image which is the image taken of the person at the second angle of depression.

### REFERENCE SIGNS LIST

1, 1a: INFORMATION PROCESSING APPARATUS
11: GENERATION UNIT
12: CREATION UNIT
13: STORAGE UNIT
14: RECOGNITION UNIT
100, 110, 120: IMAGE CAPTURING APPARATUS
200: INFORMATION PROCESSING APPARATUS
210: GENERATION UNIT
220: CREATION UNIT
230: STORAGE UNIT
240: RECOGNITION UNIT
21: VEHICLE
22: TRUCK
30: PERSON
41, 42: IMAGE REGION

What is claimed is:

1. An information processing apparatus comprising:
at least one memory storing instructions and at least one processor configured to execute the instructions to:
generate, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
create, based on the pseudo image, a recognition dictionary of the person whose image is taken at the second angle of depression.

2. The information processing apparatus according to claim 1, wherein the at least one processor is further configured to execute the instructions to:
perform projective transformation on the image region of the torso part so that a quadrilateral representing the torso part is transformed into another quadrilateral; and
perform transformation on the image region of the head part so that the viewpoint from which an image of the head part is taken is changed.

3. The information processing apparatus according to claim 1, wherein the first image is an image taken with a fisheye camera or an ultra-wide-angle camera.

4. The information processing apparatus according to claim 3, wherein the at least one processor is further configured to execute the instructions to:
designate a predetermined proportion of the first image from an upper edge of the first image as an image region of the head part, and
designate a region other than the region of the head part in the first image as the image region of the torso part in the first image.

5. The information processing apparatus according to claim 1, wherein the at least one processor is further configured to execute the instructions to:
recognize features of a person appearing in the second image taken at the second angle of depression by referring to a recognition dictionary.

6. The information processing apparatus according to claim 5, wherein a height of a first image capturing apparatus for taking the first image is different from that of a second image capturing apparatus for taking the second image.

7. The information processing apparatus according to claim 6, wherein the at least one processor is further configured to execute the instructions to:
create a recognition dictionary for each horizontal distance between the second image capturing apparatus and the person.

8-9. (canceled)

10. An information processing method comprising causing a computer to execute processes of:
generating, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
creating, based on the pseudo image, a recognition dictionary of the person whose image is taken at the second angle of depression.

11. (canceled)

12. A non-transitory computer-readable medium that stores a program for causing a computer to execute an information processing method, the method comprising:
generating means for generating, based on a first image taken of a person at a first angle of depression, a pseudo image corresponding to an image taken of the person at a second angle of depression different from the first angle of depression, in which transformation performed on an image region of a head part of the person is different from that performed on an image region of a torso part of the person; and
creating means for creating, based on the pseudo image, a recognition dictionary of the person whose image is taken at the second angle of depression.

13. (canceled)
